(19) United States
(12) Patent Application Publication
(10) Pub. No.: US 2023/0077668 A1
(43) Pub. Date: Mar. 16, 2023

(54) COATING-MATERIAL DRYING METHOD

(71) Applicant: TOYOTA JIDOSHA KABUSHIKI KAISHA, Toyota-shi (JP)

(72) Inventors: Masaki NIWA, Anjo-shi (JP); Akihiro MOTOKI, Toyohashi-shi (JP); Susumu UCHIDA, Tahara-shi (JP)

(73) Assignee: TOYOTA JIDOSHA KABUSHIKI KAISHA, Toyota-shi (JP)

(21) Appl. No.: 17/941,757

(22) Filed: Sep. 9, 2022

(30) Foreign Application Priority Data
Sep. 13, 2021 (JP) 2021-148422

(51) Int. Cl. C25D 13/22; H05B 3/00

(52) U.S. Cl. CPC C25D 13/22; H05B 3/0052

(57) ABSTRACT

A coating-material drying method for drying a coating film of a coating material applied to a vehicle body by electrodeposition coating includes: an irradiation step of applying an electromagnetic wave to the coating material staying in a gap formed in the vehicle body to decrease the viscosity of the coating material such that the coating material flows out from the gap; and a drying step of drying and hardening the coating film by heating the vehicle body after the irradiation step. In the irradiation step, a part of the vehicle body is kept at a temperature less than 110° C., the part being a part where the coating material flowing out from the gap flows.

### CROSS-REFERENCE TO RELATED APPLICATION

This application claims priority to Japanese Patent Application No. 2021-148422 filed on Sep. 13, 2021, incorporated herein by reference in its entirety.

### BACKGROUND

### 1. Technical Field

This disclosure relates to a coating-material drying method.

### 2. Description of Related Art

Japanese Unexamined Patent Application Publication No. 8-332434 (JP 8-332434 A) describes a technology in which a coating film is heated by use of hot air, infrared-rays, and high-frequency waves, so that the coating film is dried while the occurrence of a temperature difference depending on the depth position in the coating film is restrained.

### SUMMARY

In a case where a coating film is formed by electrodeposition coating on the surface of a vehicle body, a coating material deposited by the electrodeposition coating may gather in a gap of the vehicle body. The coating material thus gathering in the gap of the vehicle body might decrease the quality of the coating by flowing out over the coating film when the coating film is dried and hardened.

This disclosure is achievable in the following aspects.

(1) One aspect of this disclosure provides a coating-material drying method for drying a coating film of a coating material applied to a vehicle body by electrodeposition coating. The coating-material drying method includes: an irradiation step of applying an electromagnetic wave to the coating material staying in a gap formed in the vehicle body to decrease the viscosity of the coating material such that the coating material flows out from the gap; and a drying step of drying and hardening the coating film by heating the vehicle body after the irradiation step. In the irradiation step, a part of the vehicle body is kept at a temperature less than 110° C., the part being a part where the coating material flowing out from the gap flows.

With the coating-material drying method of this aspect, in the irradiation step prior to the drying step, it is possible to restrain boiling of the coating material and to cause the coating material to flow out from the gap. Accordingly, it is possible to restrain a decrease in the coating quality that is caused when the coating material flows out from the gap under a high temperature environment where the coating material boils.

In the coating-material drying method according to the above aspect, in the irradiation step, the electromagnetic wave may be applied such that the temperature of the coating material staying in the gap becomes equal to or more than a viscosity down temperature but less than 110° C., the viscosity down temperature being a temperature at which the viscosity of the coating material decreases to be lower than a predetermined viscosity.

With the coating-material drying method of this aspect, it is possible to cause the coating material to effectively flow out from the gap. Further, the temperature of the coating material is maintained to be less than 110° C., and therefore, it is possible to restrain bumping of the coating material flowing out from the gap from leaving marks on the coating film.

In the coating-material drying method according to the above aspect, the viscosity down temperature may be 80° C.

With the coating-material drying method of this aspect, it is possible to cause the coating material having a viscosity down temperature of 80° C. to effectively flow out from the gap.

In the coating-material drying method according to the above aspect, the electromagnetic wave may have a peak wavelength equal to or more than 1.5 micrometers but less than 3.0 micrometers.

With the coating-material drying method of this aspect, it is possible to retrain an increase in the temperature of the vehicle body and to decrease the viscosity of the coating material staying in the gap by heating the coating material.

In the coating-material drying method according to the above aspect, a step of causing the coating material to flow out from the gap by jetting out fluid to the vehicle body on which the coating film is formed may not be provided before the irradiation step.

With the coating-material drying method of this aspect, it is possible to reduce consumed energy to cause the coating material to flow out from the gap in comparison with a case where the step of causing the coating material to flow out from the gap by jetting out fluid to the vehicle body on which the coating film is formed is provided.

In the coating-material drying method according to the above aspect, a step of removing the coating material flowing out from the gap by jetting out fluid to the vehicle body on which the coating film is formed may not be provided between the irradiation step and the drying step.

With the coating-material drying method of this aspect, it is possible to reduce consumed energy in comparison with a case where the step of removing the coating material to flow out from the gap by jetting out fluid to the vehicle body on which the coating film is formed is provided.

This disclosure is achievable in various forms other than the coating-material drying method. For example, this disclosure can be achieved in the form of an electrodeposition coating method, a coating-material drying apparatus, an electrodeposition coating system, and the like, for example.

### BRIEF DESCRIPTION OF THE DRAWINGS

Features, advantages, and technical and industrial significance of exemplary embodiments of the present disclosure will be described below with reference to the accompanying drawings, in which like signs denote like elements, and wherein:

FIG. 1 is an explanatory view schematically illustrating a configuration of an electrodeposition coating system;

FIG. 2 is an explanatory view illustrating the relationship between respective peak wavelengths of infrared heaters and respective absorption wavelength regions of materials;

FIG. 3 is a graph illustrating the relationship between temperature and viscosity in a coating material;

FIG. 4 is an explanatory view illustrating a configuration of a hem portion provided in a vehicle body;

FIG. 5 is a flowchart illustrating the procedure of an electrodeposition coating method;

FIG. 6 is a first explanatory view illustrating the state of an infrared irradiation step in the electrodeposition coating method;

FIG. 7 is a second explanatory view illustrating the state of the infrared irradiation step in the electrodeposition coating method;

FIG. 8 is a first image illustrating a test result about the coating quality of electrodeposition coating;

FIG. 9 is a second image illustrating a test result about the coating quality of the electrodeposition coating;

FIG. 10 is a third image illustrating a test result about the coating quality of the electrodeposition coating; and

FIG. 11 is a fourth image illustrating a test result about the coating quality of the electrodeposition coating.

### DETAILED DESCRIPTION OF EMBODIMENTS

### A. First Embodiment

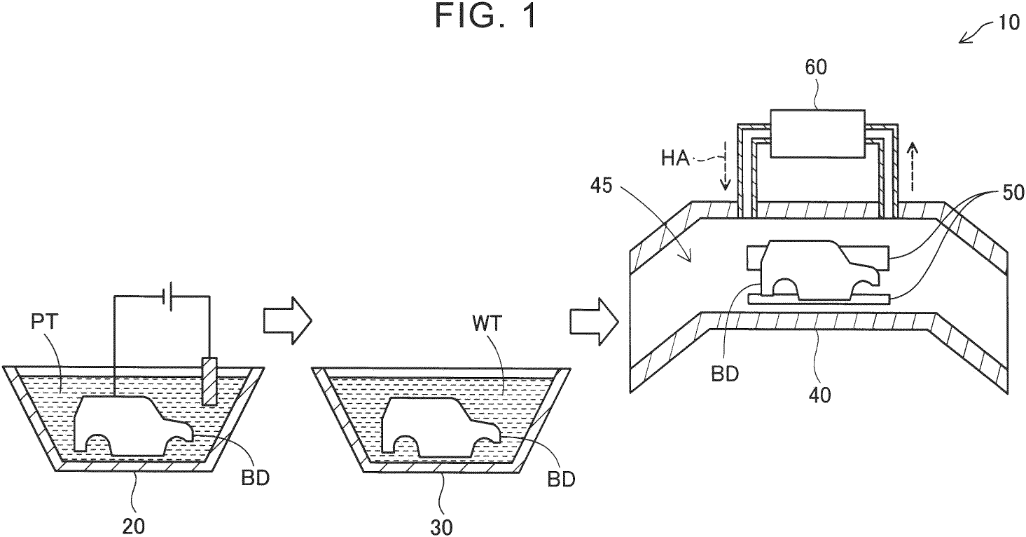

FIG. 1 is an explanatory view schematically illustrating a schematic configuration of an electrodeposition coating system 10 used for an electrodeposition coating method including a coating-material drying method in a first embodiment. In the present embodiment, the electrodeposition coating system 10 is placed in an automobile manufacturing factory and is used to perform electrodeposition coating on a vehicle body BD of an automobile. Note that the electrodeposition coating system 10 may not be used for the vehicle body BD of the automobile and may be used to perform electrodeposition coating on a vehicle body of a motorcycle or a vehicle body of a railway vehicle, for example.

The vehicle body BD is constituted by a plurality of metal members in combination. In the present embodiment, the vehicle body BD is a body shell of the automobile, and the body shell includes a monocoque, a bonnet hood, a door panel, and a tailgate. A glass component such as a windshield or a resin component such as a bumper is not included in the vehicle body BD. The vehicle body BD may include a trunk lid instead of the tailgate. Note that the vehicle body BD is not limited to the body shell and may be a component constituting the body shell. For example, the vehicle body BD may be part of the monocoque or the door panel.

In the electrodeposition coating system 10, the vehicle body BD is conveyed along a predetermined path. The electrodeposition coating system 10 includes a coating pan 20, a water tank 30, and a drying furnace 40. The coating pan 20, the water tank 30, and the drying furnace 40 are placed in this order along a conveyance path of the vehicle body BD.

A liquid electrodeposition coating material PT is accumulated in the coating pan 20. The electrodeposition coating material PT is an aqueous coating material and is constituted by water, resin, pigment, a neutralizer, and so on. In the present embodiment, the electrodeposition coating material PT contains titanium oxide by 15% to 20%, ethylene glycol mono-normal-butyl-ether by 1% to 5%, dioctyltin oxide by 1% to 5%, carbon black by 0.1% to 1%, zinc oxide by 0.1% to 1%, and methyl isobutyl ketone by 0.1% to 1%. The boiling point of the electrodeposition coating material PT is, for example, 100 to 171° C. In the following description, the electrodeposition coating material PT is just referred to as the coating material PT unless otherwise specified. Water WT is accumulated in the water tank 30.

The drying furnace 40 is provided with a tunnel-shaped furnace inner passage 45 where the vehicle body BD is conveyed. A wall surface of the furnace inner passage 45 is provided with a heat insulation material. An infrared heater 50 is placed in the furnace inner passage 45. The infrared heater 50 emits infrared rays toward the vehicle body BD conveyed in the furnace inner passage 45. The drying furnace 40 is provided with a hot-air supply device 60 configured to supply hot air HA to the furnace inner passage 45. The hot air HA supplied from the hot-air supply device 60 to the furnace inner passage 45 circulates to the hot-air supply device 60. Note that the drying furnace 40, the infrared heater 50, and the hot-air supply device 60 may be referred to as a coating-material drying apparatus.

In the present embodiment, the peak wavelength of the infrared rays generated by the infrared heater 50 is equal to or more than 1.5 µm but less than 3.0 µm. The peak wavelength of the infrared rays indicates a wavelength at which the radiant intensity of the infrared rays is maximum. In the following description, infrared rays having a wavelength of less than 1.5 µm are referred to as near-infrared rays, infrared rays having a wavelength of 1.5 µm or more but less than 3.0 µm are referred to as mid-infrared rays, and infrared rays having a wavelength of 3.0 µm or more are referred to as far-infrared rays. An infrared heater having a peak wavelength in a wavelength region of the near-infrared rays is referred to as a near-infrared heater, an infrared heater having a peak wavelength in a wavelength region of the mid-infrared rays is referred to as a mid-infrared heater, and an infrared heater having a peak wavelength in a wavelength region of the far-infrared rays is referred to as a far-infrared heater. In the present embodiment, the infrared heater 50 is a mid-infrared heater and is constituted by a carbon heater, for example.

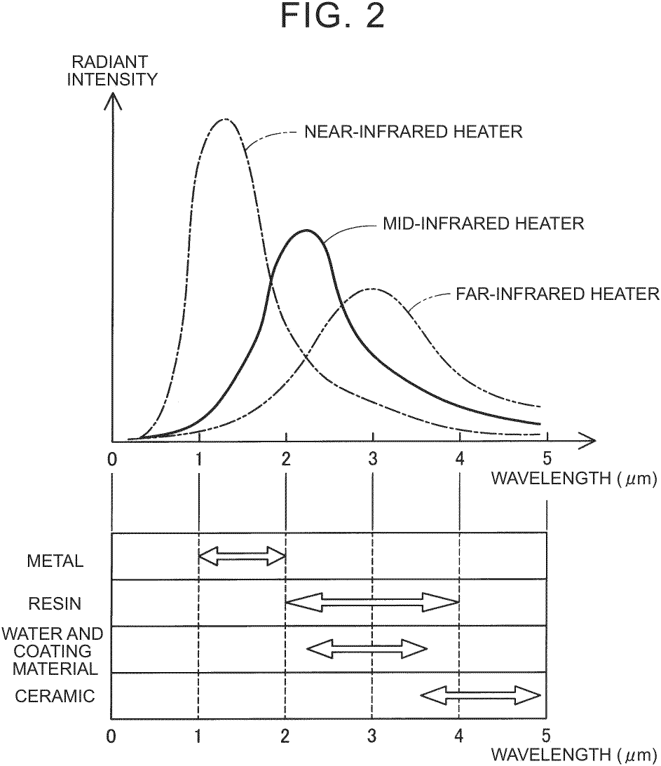

FIG. 2 is an explanatory view illustrating the relationship between respective peak wavelengths of the infrared heaters and respective absorption wavelength regions of various materials. On the upper side of FIG. 2, the relationship between wavelength and radiant intensity in each of the infrared rays generated by the infrared heaters is illustrated, and on the lower side of FIG. 2, the respective absorption wavelength regions of the various materials are indicated by arrows. As the peak wavelength of infrared rays applied to a to-be-heated object by an infrared heater is closer to the absorption wavelength region of the to-be-heated object, the to-be-heated object can be effectively heated by radiant heating by the infrared heater. Since the peak wavelength of the infrared rays generated by the near-infrared heater is close to the absorption wavelength region of metal, the near-infrared heater can heat the metal effectively. Since the peak wavelength of the infrared rays generated by the mid-infrared heater is close to the absorption wavelength regions of resin, water, and a coating material, the mid-infrared heater can heat the resin, the water, and the coating material effectively. Since the peak wavelength of the infrared rays generated by the far-infrared heater is close to the absorption wavelength region of ceramic, the far-infrared heater can heat the ceramic effectively.

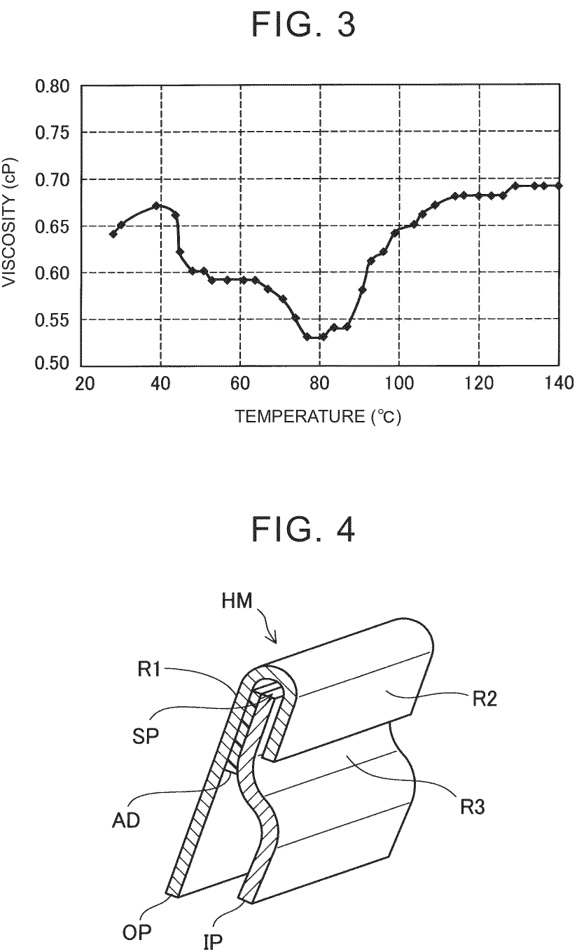

FIG. 3 is a graph illustrating the relationship between temperature and viscosity in a coating material PT in the present embodiment. In the present embodiment, when the temperature of the coating material PT is 80° C., the viscosity of the coating material PT is minimum. In a range where the temperature of the coating material PT is equal to or more than 20° C. but less than 40° C., the viscosity of the coating material PT is higher as the temperature of the coating material PT is higher. In a range where the temperature of the coating material PT is equal to or more than 40° C. but equal to or less than 80° C., the viscosity of the coating material PT is lower as the temperature of the coating material PT is higher. When the temperature of the coating material PT exceeds 80° C., the viscosity of the coating material PT is higher as the temperature of the coating material PT is higher.

FIG. 4 is an explanatory view illustrating a configuration of a hem portion HM provided in the vehicle body BD. In the present embodiment, the vehicle body BD includes the hem portion HM. The hem portion HM indicates a part formed such that an end portion of a plate member constituting the vehicle body BD is bent to sandwich an end portion of another plate member constituting the vehicle body BD. The hem portion HM is provided in a side sill, a bonnet hood, a door panel, or a tailgate, for example.

In FIG. 4, the hem portion HM is provided such that an end portion of an outer panel OP is bent to sandwich an end portion of an inner panel IP. In the following description, in the outer panel OP, a part placed on the outer side of the vehicle body BD relative to the inner panel IP is referred to as an outer portion R1, and a part placed on the inner side of the vehicle body BD relative to the inner panel IP is referred to as an inner portion R2. In the inner panel IP, a part that does not overlap with the inner portion R2 of the outer panel OP is referred to as a non-overlapping portion R3. A part between the outer portion R1 of the outer panel OP and the end portion of the inner panel IP is sealed by an adhesive AD. The adhesive AD is made of thermosetting resin such as epoxy resin, for example. The hem portion HM has a gap SP defined by the outer panel OP, the inner panel IP, and the adhesive AD. The gap SP communicates with the space inside the vehicle body BD.

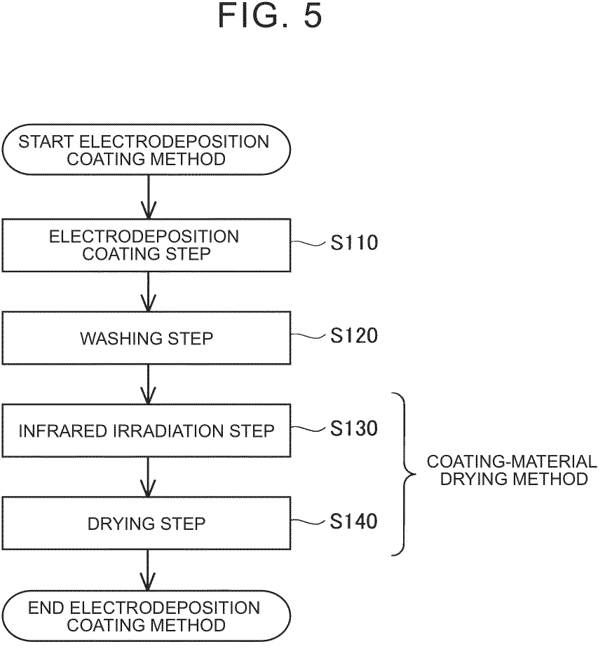

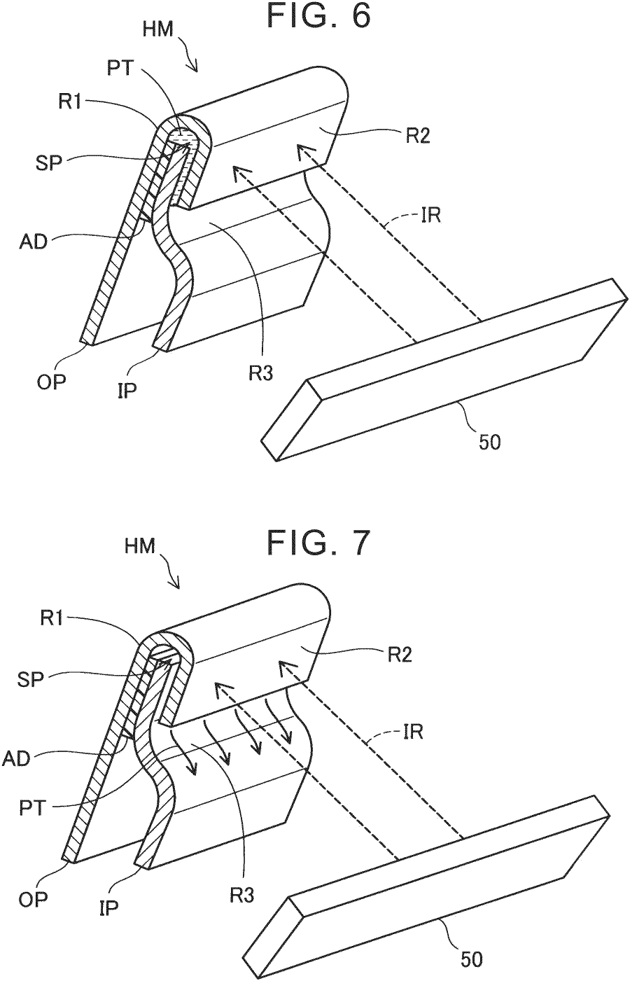

FIG. 5 is a flowchart illustrating the procedure of an electrodeposition coating method performed in the electrodeposition coating system 10 in the present embodiment. FIG. 6 is a first explanatory view illustrating the state of an infrared irradiation step of the electrodeposition coating method in the present embodiment. FIG. 7 is a second explanatory view illustrating the state of the infrared irradiation step of the electrodeposition coating method in the present embodiment. As illustrated in FIG. 5, in the present embodiment, the electrodeposition coating method includes an electrodeposition coating step, a washing step, the infrared irradiation step, and a drying step. Note that the infrared irradiation step may be just referred to as an irradiation step.

First, in the electrodeposition coating step in step S110, the vehicle body BD on which a surface treatment such as degreasing is performed is immersed in a liquid coating material PT accumulated in the coating pan 20, so that electrodeposition coating is performed on the vehicle body BD. When the electrodeposition coating is performed on the vehicle body BD, a coating film of the coating material PT is formed on the vehicle body BD. In the present embodiment, cathodic electrodeposition coating with the vehicle body BD being taken as a cathode is performed, so that the coating film of the coating material PT is formed on the vehicle body BD. The vehicle body BD subjected to the electrodeposition coating is conveyed to the water tank 30. When the electrodeposition coating is performed on the vehicle body BD, the liquid coating material PT inevitably stays in the gap SP of the hem portion HM. Note that, in another embodiment, the coating film of the coating material may be formed on the vehicle body BD such that anodic electrodeposition coating with the vehicle body BD being taken as an anode is performed on the vehicle body BD.

Then, in the washing step in step S120, an excess coating material PT attached to the vehicle body BD is washed away. In the present embodiment, the vehicle body BD is immersed in water WT accumulated in the water tank 30, so that the excess coating material PT attached to the vehicle body BD is washed away. The vehicle body BD thus washed is conveyed to the furnace inner passage 45 of the drying furnace 40. Note that it is preferable that the excess coating material PT thus washed away from the vehicle body BD be recovered by an ultra-filtration (UF) device and returned back to the coating pan 20, for example.

In the infrared irradiation step in step S130, a part of the vehicle body BD that defines the gap of the vehicle body BD is irradiated with infrared rays. Hereby, the coating material PT staying in the gap of the vehicle body BD is heated, so that the viscosity of the coating material PT is decreased and the coating material PT flows out from the gap of the vehicle body BD. In the following description, the temperature of the coating material PT at which the viscosity of the coating material PT decreases to be equal to or less than a predetermined viscosity is referred to as a viscosity down temperature. In the present embodiment, the coating material PT staying in the gap of the vehicle body BD is heated so that the temperature of the coating material PT staying in the gap of the vehicle body BD becomes equal to or more than the viscosity down temperature but does not to exceed the boiling point of water. More specifically, the coating material PT staying in the gap of the vehicle body BD is heated so that the temperature of the coating material PT staying in the gap of the vehicle body BD becomes equal to or more than 80° C. but does not to exceed the boiling point of water. Further, in the present embodiment, in the infrared irradiation step, the temperature of a part of the vehicle body BD on which the coating material PT flowing out from the gap of the vehicle body BD flows is maintained to be equal to or more than the room temperature but less than 110° C. In the infrared irradiation step, the pressure in the furnace inner passage 45 is maintained at the atmospheric pressure.

As illustrated in FIG. 6, in the present embodiment, in the infrared irradiation step, mid-infrared rays IR are emitted from the infrared heater 50 toward the gap SP of the hem portion HM. More specifically, the inner portion R2 of the outer panel OP in the hem portion HM is irradiated with the mid-infrared rays IR emitted from the infrared heater 50. The mid-infrared rays IR applied to the inner portion R2 pass through the inner portion R2 such that the mid-infrared rays IR are absorbed by the coating material PT staying in the gap SP. Accordingly, when the inner portion R2 is irradiated with the mid-infrared rays IR, the coating material PT staying in the gap SP is heated. Note that, in another embodiment, the outer portion R1 of the outer panel OP in the hem portion HM may be irradiated with the mid-infrared rays IR emitted from the infrared heater 50 such that the coating material PT staying in the gap SP of the hem portion HM is heated. A part defining a gap of the vehicle body BD other than the gap SP of the hem portion HM may be irradiated with the mid-infrared rays IR emitted from the infrared heater 50 such that the coating material PT staying in the gap of the vehicle body BD other than the gap SP of the hem portion HM is heated.

In the present embodiment, as described above, in the infrared irradiation step, the coating material PT staying in the gap SP of the hem portion HM is heated so that the temperature of the coating material PT staying in the gap SP becomes equal to or more than 80° C. but does not to exceed the boiling point of water. As illustrated in FIG. 3, in the present embodiment, when the temperature of the coating material PT is 80° C., the viscosity of the coating material PT is minimum. On that account, by heating with the infrared heater 50, the flowability of the coating material PT staying in the gap SP increases, so that the coating material PT flows out from the gap SP. As illustrated in FIG. 7, the coating material PT flowing out from the gap SP flows along the non-overlapping portion R3 of the inner panel IP and is melted into an undried coating film of the coating material PT that is formed in the non-overlapping portion R3. In the present embodiment, in the infrared irradiation step, the temperature of the non-overlapping portion R3 is maintained to be equal to or more than the room temperature but less than 110° C. The temperature of the non-overlapping portion R3 can be measured by use of a thermocouple thermometer, for example. It is difficult to measure the temperature of the coating material PT itself. In view of this, the temperature of the coating material PT may be checked by measuring the temperature of an object coated with the coating material PT by use of the thermocouple thermometer, for example.

In the present embodiment, in the infrared irradiation step, the distance between the infrared heater 50 and the hem portion HM is maintained to be a predetermined distance equal to or more than 100 mm but equal to or less than 300 mm. In a case where the distance between the infrared heater 50 and the hem portion HM is maintained to be 100 mm, the mid-infrared rays IR are applied to the hem portion HM from the infrared heater 50 for a predetermined period of time of 10 seconds or more but 40 seconds or less, for example. In a case where the distance between the infrared heater 50 and the hem portion HM is maintained to be 200 mm, the mid-infrared rays IR are applied to the hem portion HM from the infrared heater 50 for a predetermined period of time of 70 seconds or more but 80 seconds or less, for example. The length of the time during which the mid-infrared rays IR are applied to the hem portion HM from the infrared heater 50 can be determined based on the output of the infrared heater 50, the distance between the infrared heater 50 and the hem portion HM, or the type of the coating material PT.

In the drying step in step S140, the coating film of the coating material PT that is formed on the vehicle body BD is heated so that the coating film of the coating material PT that is formed on the vehicle body BD is dried and hardened. In the present embodiment, the coating film of the coating material PT that is formed on the vehicle body BD is heated by hot air HA supplied to the furnace inner passage 45 from the hot-air supply device 60, so that the coating film of the coating material PT is dried and hardened. The coating film of the coating material PT is heated by the hot air HA supplied to the furnace inner passage 45 from the hot-air supply device 60 such that the temperature of the coating film reaches a temperature equal to or more than the hardening temperature of the coating material PT. The hardening temperature of the coating material PT is equal to or more than 110° C. and is, for example, 180° C. The temperature of the hot air HA supplied to the furnace inner passage 45 from the hot-air supply device 60 can be determined based on the hardening temperature of the coating material PT.

After the drying step is finished, this method is ended. After that, middle coating and base coating are performed on the vehicle body BD. After the base coating, clear coating may be performed on the vehicle body BD. The electrodeposition coating may be also referred to as primer coating. The processes from the infrared irradiation step of step S130 to the drying step of step S140 may be also referred to as a coating-material drying method. Note that the electrodeposition coating method of the present embodiment does not include, between the electrodeposition coating step and the infrared irradiation step, a step of causing the coating material PT staying in a gap of the vehicle body BD such as the gap SP of the hem portion HM to flow out from the gap by jetting out fluid such as hot water or compressed air to the vehicle body BD on which the coating film of the coating material PT is formed, for example. The hot water indicates water having a temperature of 40° C. or more, for example. Further, the electrodeposition coating method of the present embodiment does not include, between the infrared irradiation step and the drying step, a step of removing the coating material PT flowing out from a gap of the vehicle body BD such as the gap SP of the hem portion HM by jetting out fluid such as hot water or compressed air to the vehicle body BD on which the coating film of the coating material PT is formed, for example.

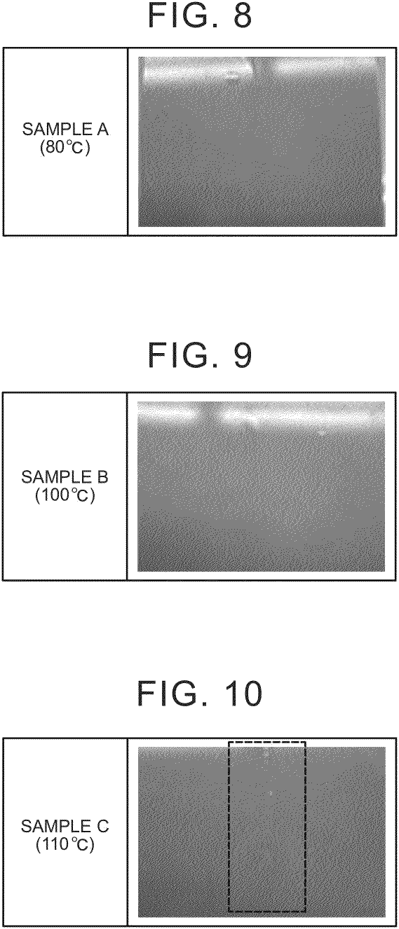

FIGS. 8 to 11 are images illustrating test results about the coating quality of the electrodeposition coating performed on the vehicle body BD. The test was performed such that a sample A, a sample B, a sample C, and a sample D were formed by changing the temperature of the non-overlapping portion R3 of the hem portion HM in the infrared irradiation step, and the relationship of the temperature of the non-overlapping portion R3 in the infrared irradiation step with the coating quality of the electrodeposition coating was examined.

FIG. 8 illustrates the appearance of the non-overlapping portion R3 of the sample A. In the sample A, the temperature of the non-overlapping portion R3 in the infrared irradiation step was kept at 80° C. In the sample A, the surface of the coating film of the coating material PT that was formed on the non-overlapping portion R3 was smooth. On this account, the coating quality of the electrodeposition coating is good.

FIG. 9 illustrates the appearance of the non-overlapping portion R3 of the sample B. In the sample B, the temperature of the non-overlapping portion R3 in the infrared irradiation step was kept at 100° C. In the sample B, the surface of the coating film of the coating material PT that was formed on the non-overlapping portion R3 was smooth. On this account, the coating quality of the electrodeposition coating is good.

FIG. 10 illustrates the appearance of the non-overlapping portion R3 of the sample C. In the sample C, the temperature of the non-overlapping portion R3 in the infrared irradiation step was kept at 110° C. In the sample C, minute recesses and projections were formed in a region surrounded by a broken line in FIG. 10 on the surface of the coating film of the coating material PT that was formed in the non-overlapping portion R3.

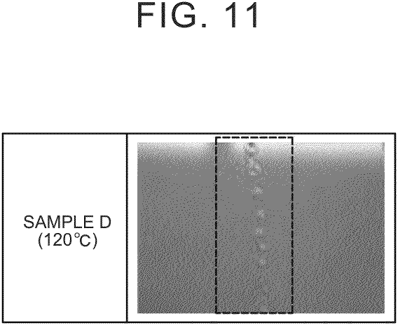

FIG. 11 illustrates the appearance of the non-overlapping portion R3 of the sample D. In the sample D, the temperature of the non-overlapping portion R3 in the infrared irradiation step was kept at 120° C. In the sample D, obvious recesses and projections were formed in a region surrounded by a broken line in FIG. 11 on the surface of the coating film of the coating material PT that was formed in the non-overlapping portion R3. The number of the recesses and projections formed on the coating film of the sample D is larger than the number of the recesses and projections formed on the coating film of the sample C. The sizes of the recesses and projections formed on the coating film of the sample D are larger than the sizes of the recesses and projections formed on the coating film of the sample C.

According to the test results, in order to increase the coating quality of the electrodeposition coating, it is preferable that the temperature of the non-overlapping portion R3 in the infrared irradiation step be kept at a temperature less than 120° C., it is more preferable that the temperature of the non-overlapping portion R3 in the infrared irradiation step be kept at a temperature less than 110° C., and it is further preferable that the temperature of the non-overlapping portion R3 in the infrared irradiation step be kept at a temperature equal to or less than 100° C.

In the electrodeposition coating method in the present embodiment that has been described above, in the infrared irradiation step performed prior to the drying step, the hem portion HM is irradiated with infrared rays from the infrared heater 50, so that the coating material PT staying in the gap SP of the hem portion HM is heated and the coating material PT flows out from the gap SP. This makes it possible to restrain the coating material PT from flowing out from the gap SP in the drying step. Further, in the present embodiment, in the infrared irradiation step, the temperature of the non-overlapping portion R3 where the coating material PT flowing out from the gap SP of the hem portion HM flows is maintained to be less than 110° C. Accordingly, it is possible to restrain recesses and projections from being formed on the undried coating film of the coating material PT such that the coating material PT flowing out from the gap SP boils on the undried coating film before the coating material PT thus flowing out is melted into the undried coating film. Accordingly, with the electrodeposition coating method of the present embodiment, it is possible to restrain a decrease in the coating quality that is caused when the coating material PT flows out from the gap SP of the hem portion HM under a high temperature environment where the coating material PT boils.

Further, in the present embodiment, the viscosity of the coating material PT is minimum when the temperature of the coating material PT is 80° C., and the hem portion HM is irradiated with the infrared rays from the infrared heater 50 so that the temperature of the coating material PT staying in the gap SP of the hem portion HM becomes equal to or more than 80° C. in the infrared irradiation steps. Accordingly, in comparison with a case where the hem portion HM is irradiated with the infrared rays from the infrared heater 50 so that the temperature of the coating material PT staying in the gap SP of the hem portion HM does not become equal to or more than 80° C. in the infrared irradiation step, it is possible to easily cause the coating material PT to flow out from the gap SP. Further, in the present embodiment, the hem portion HM is irradiated with the infrared rays from the infrared heater 50 so that the temperature of the coating material PT staying in the gap SP of the hem portion HM does not exceed the boiling point of water in the infrared irradiation step. This accordingly makes it possible to restrain bumping of the coating material PT flowing out from the gap SP of the hem portion HM from leaving marks on the coating film of the coating material PT.

Further, in the present embodiment, the hem portion HM is irradiated with infrared rays having a peak wavelength in the wavelength region of the mid-infrared rays from the infrared heater 50. Accordingly, it is possible to restrain the temperature of the metal outer panel OP or the metal inner panel IP constituting the hem portion HM from increasing, and it is possible to decrease the viscosity of the coating material PT staying in the gap SP of the hem portion HM by heating the coating material PT.

Further, in the present embodiment, instead of causing the coating material PT staying in the gap SP of the hem portion HM to flow out by jetting out hot water generated by heating with a gas burner or the like to the vehicle body BD by use of a shower device or the like, the coating material PT is caused to flow out from the gap SP of the hem portion HM by applying the infrared rays to the hem portion HM from the infrared heater 50 placed in the furnace inner passage 45 of the drying furnace 40. Accordingly, in comparison with a case where the shower device or the like is provided, it is possible to decrease the occupation area of the electrodeposition coating system 10 in an automotive manufacturing factory. Further, in the present embodiment, it is possible to efficiently heat the coating material PT staying in the gap SP of the hem portion HM by radiant heating with the infrared heater 50. Accordingly, it is possible to reduce consumed energy of the electrodeposition coating system 10 in comparison with a case where hot water is jetted out from the shower device to the vehicle body BD.

Further, in the present embodiment, as described above, the coating material PT flowing out from the gap SP of the hem portion HM flows along the non-overlapping portion R3 of the inner panel IP and is melted into the undried coating film of the coating material PT that is formed on the non-overlapping portion R3. Accordingly, a step of removing the coating material PT flowing out from the gap SP of the hem portion HM by jetting out fluid such as hot water or compressed air to the vehicle body BD on which the coating film of the coating material PT is formed is not provided between the infrared irradiation step and the drying step. Accordingly, it is possible to reduce the consumed energy of the electrodeposition coating system 10 in comparison with a case where the step of removing the coating material PT flowing out from the gap SP of the hem portion HM by jetting out fluid such as hot water or compressed air to the vehicle body BD on which the coating film of the coating material PT is formed is provided.

### B. Other Embodiments

(B1) In the electrodeposition coating method of the above embodiment, in the infrared irradiation step, the coating material PT staying in the gap SP of the hem portion HM is heated such that the hem portion HM is irradiated with the infrared rays having a peak wavelength in the wavelength region of the mid-infrared rays from the infrared heater 50. In the meantime, in the infrared irradiation step, the coating material PT staying in the gap SP of the hem portion HM may be heated such that the hem portion HM is irradiated with infrared rays having a peak wavelength in the wavelength region of the near-infrared rays from the infrared heater 50. In this case, the infrared heater 50 may be constituted by a halogen heater, for example. Further, in the infrared irradiation step, the coating material PT staying in the gap SP of the hem portion HM may be heated such that the hem portion HM is irradiated with an electromagnetic wave other than the infrared rays.

(B2) In the electrodeposition coating method of the above embodiment, in the infrared irradiation step, the coating material PT staying in the gap SP of the hem portion HM is heated by the infrared heater 50 so that the temperature of the coating material PT staying in the gap SP becomes equal to or more than 80° C. In the meantime, in the infrared irradiation step, the coating material PT staying in the gap SP of the hem portion HM may be heated by the infrared heater 50 so that the temperature of the coating material PT staying in the gap SP does not become equal to or more than 80° C. For example, the coating material PT staying in the gap SP may be heated by the infrared heater 50 so that the viscosity of the coating material PT becomes lower by 10% or more than the viscosity of the coating material PT at 27° C. and the temperature of the coating material PT does not become equal to or more than 80° C. Further, for example, in a case where a coating material the viscosity of which is minimum at the time when the temperature of the coating material is 70° C. is used in the electrodeposition coating for the vehicle body BD, the hem portion HM may be irradiated from the infrared heater 50 in the infrared irradiation step so that the temperature of the coating material staying in the gap SP of the hem portion HM becomes equal to or more than 70° C. but less than 80° C.

(B3) The electrodeposition coating method of the above embodiment does not include, between the electrodeposition coating step and the infrared irradiation step, a step of causing the coating material PT staying in the gap SP of the hem portion HM to flow out from the gap SP by jetting out fluid such as hot water or compressed air to the vehicle body BD on which the coating film of the coating material PT is formed. In the meantime, the electrodeposition coating method may include, between the electrodeposition coating step and the drying step, a step of causing the coating material PT staying in the gap SP of the hem portion HM to flow out from the gap SP by jetting out fluid such as hot water or compressed air to the vehicle body BD. In this case, it is possible to effectively restrain the coating material PT from flowing out from the gap SP in the drying step.

(B4) The electrodeposition coating method of the above embodiment does not include, between the infrared irradiation step and the drying step, a step of removing the coating material PT flowing out from the gap SP of the hem portion HM by jetting out fluid such as hot water or compressed air to the vehicle body BD on which the coating film of the coating material PT is formed. In the meantime, the electrodeposition coating method may include, between the infrared irradiation step and the drying step, the step of removing the coating material PT flowing out from the gap SP of the hem portion HM by jetting out fluid such as hot water or compressed air to the vehicle body BD on which the coating film of the coating material PT is formed. In this case, it is possible to restrain such a situation that, when the amount of the coating material PT staying in the gap SP is large, part of the coating material PT flowing out from the gap SP is not melted into the coating film of the coating material PT that is formed on the vehicle body BD, and recesses and projections are formed on the coating film of the coating material PT.

The disclosure is not limited to the above embodiments and is achievable in various configurations within a range that does not deviate from the gist of the disclosure. For example, in order to achieve some of or all of the objects or to achieve some of or all of the effects, the technical features in the embodiments that correspond to the technical features in the aspects described in the field of SUMMARY can be replaced or combined appropriately. Further, the technical features can be deleted appropriately if the technical features have not been described as essential in the present specification.

What is claimed is:

1. A coating-material drying method for drying a coating film of a coating material applied to a vehicle body by electrodeposition coating, the coating-material drying method comprising:
an irradiation step of applying an electromagnetic wave to the coating material staying in a gap formed in the vehicle body to decrease a viscosity of the coating material such that the coating material flows out from the gap; and
a drying step of drying and hardening the coating film by heating the vehicle body after the irradiation step, wherein, in the irradiation step, a part of the vehicle body is kept at a temperature less than 110° C., the part being a part where the coating material flowing out from the gap flows.

2. The coating-material drying method according to claim 1, wherein, in the irradiation step, the electromagnetic wave is applied such that the temperature of the coating material staying in the gap becomes equal to or more than a viscosity down temperature but less than 110° C., the viscosity down temperature being a temperature at which the viscosity of the coating material decreases to be lower than a predetermined viscosity.

3. The coating-material drying method according to claim 1, wherein the viscosity down temperature is 80° C.

4. The coating-material drying method according to claim 1, wherein the electromagnetic wave has a peak wavelength equal to or more than 1.5 micrometers but less than 3.0 micrometers.

5. The coating-material drying method according to claim 1, wherein a step of causing the coating material to flow out from the gap by jetting out fluid to the vehicle body on which the coating film is formed is not provided before the irradiation step.

6. The coating-material drying method according to claim 1, wherein a step of removing the coating material flowing out from the gap by jetting out fluid to the vehicle body on which the coating film is formed is not provided between the irradiation step and the drying step.
